(19) United States
(12) Patent Application Publication
(10) Pub. No.: US 2004/0187004 A1
(43) Pub. Date: Sep. 23, 2004

(54) Method of embedding and extracting information using induced affine transformations

(75) Inventors: Lawrence A. Ray, Rochester, NY (US); Chris W. Honsinger, Ontario, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/389,031

(22) Filed: Mar. 14, 2003

(51) Int. Cl. H04L 9/00

(52) U.S. Cl. 713/176

(57) ABSTRACT

A method of embedding information in an image or video, comprising associating information with a affine transformation, inducing the effect of the affine transformation on an array of steganographically encoded signals, to form a transformed steganographic signal and combining the transformed steganographic signal with an image or video. Furthermore, a method of extracting information from a transformed steganographic signal embedded in an image or video, comprising autocorrelating the embedded image or video to determine an induced affine transformation and using the determined affine transformation as an index into a database containing information.

### FIELD OF THE INVENTION

The invention utilizes aspects of data embedding. The science or art of data embedding is also referred to as data hiding, information hiding, data embedding, watermarking and steganography. More particularly, the invention relates to the art and science of recovering from rotation, scale, and skew induced by processing the image. Furthermore, and more directly, the present invention describes how to use synthetically induced rotation, scale and skew distortions in the design of the embedded signal order to carry additional information without substantially taxing the information capacity of the embedded algorithm.

### BACKGROUND OF THE INVENTION

In most robust algorithms used for data-embedding the embedded signal is repeated many times across an image, video or sound track. It is known (see Honsinger, et al., U.S. Pat. No. 5,835,639, issued Nov. 10, 1998, entitled “Method For Detecting Rotation and Magnification In Images,” and U.S. Ser. No. 09/452,415, filed Dec. 1, 1999, entitled “Method and Computer Program For Detecting Rotation and Magnification of Images,” by Chris W. Honsinger) that repeated embedded signals can be used to correct for rotation, magnification and shearing or skewing.

The amount of data typically stored steganographically is in the order of 100 bits. Consequently, an apparently small number of additional bits of data can be extremely valuable. The additional data can be used for a multitude of purposes, including, but not limited to: providing independent check bits for the message contained in the steganographic packet; a public key for decoding an encrypted signal that is encoded using a public-private key infrastructure; a pointer designating the type of steganographic algorithm used to encode remaining bits; and extra bandwidth for any application.

The current invention provides these extra bits and enables these applications.

### SUMMARY OF THE INVENTION

The present invention provides extra bandwidth for conveying information in a steganographic application by purposefully skewing, magnifying, or rotating an embedded signal that has been repetitiously placed on an image or video.

### BRIEF DESCRIPTION OF THE DRAWINGS

FIG. 1 illustrates a computer system for implementing the present invention;

FIG. 2 represents a picture printed on an ID card of the present invention;

FIG. 3 is the auto-correlation map of an embedded image, when not exposed to rotation, skewing or scaling;

FIG. 4 is an example of an image rotated at 20 degrees;

FIG. 5 is an example of an image that is reduced in scale by 50% and rotated by 20 degrees;

FIG. 6 is a steganographically encoded facial image that has undergone rotation and scale;

FIG. 7 is an auto-correlation map of the possible purposefully induced auto-correlation peaks for rotation and scale (aspect ratio maintained);

FIG. 8 is a two-dimensional look up table;

FIG. 9 is an example of a skewed image and an auto-correlation map of a skewed image;

FIG. 10 is an image with a purposely induced affine transformation that has two nontrivial auto-correlation peaks;

FIG. 11 is an auto-correlation map as shown in FIG. 10; and

FIG. 12 is an expanded view of an auto-correlation map generated by a purposely induced affine transform.

### DETAILED DESCRIPTION OF THE INVENTION

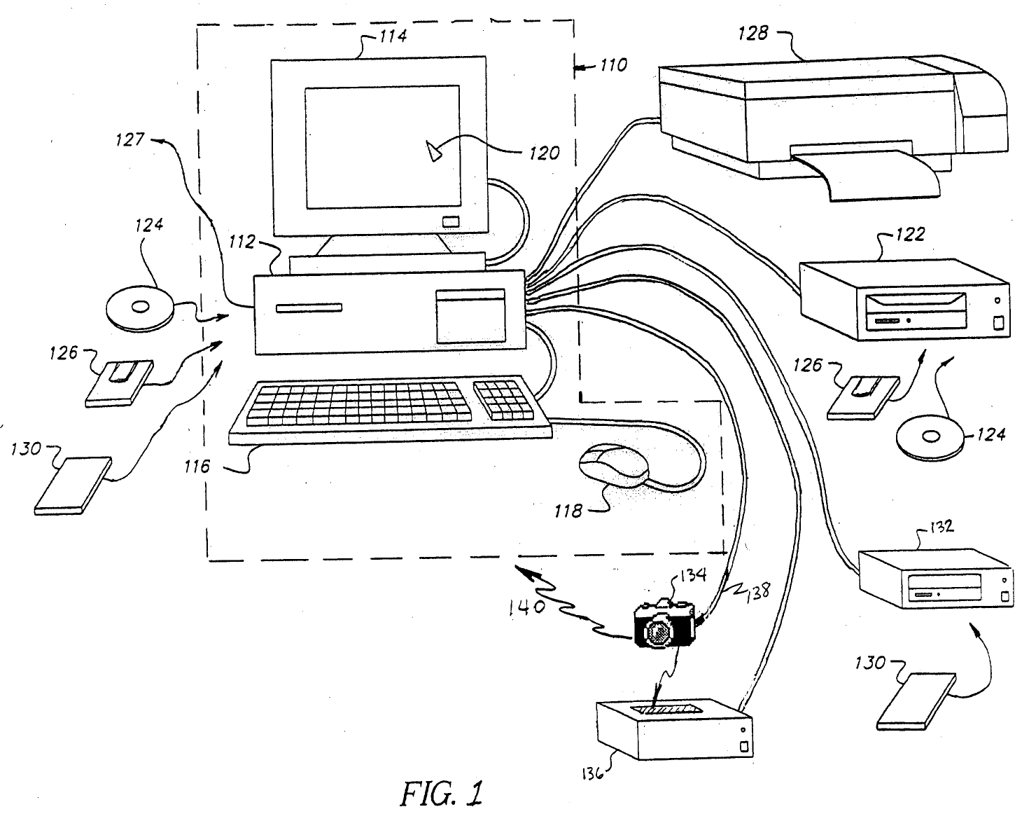

Referring to FIG. 1, there is illustrated a computer system 110 for implementing the present invention. Although the computer system 110 is shown for the purpose of illustrating a preferred embodiment, the present invention is not limited to the computer system 110 shown, but may be used on any electronic processing system such as found in home computers, kiosks, retail or wholesale photo-finishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor-based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor-based unit 112 for providing a means of inputting the software programs and other information to the microprocessor-based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into externally located disk drive unit 122 which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images may also be displayed on the display 114 via a personal computer card (PC card) 130, such as, as it was formerly known, a PCMCIA card (based on the specifications of the Personal Computer Memory Card International Association) which contains digitized images electronically embodied in the PC card 130. The PC card 130 is ultimately inserted into the microprocessor-based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images stored in the PC card 130, the floppy disk 126 or the compact disk 124, or input through the network connection 127, may have been obtained from a variety of sources, such as a digital camera (not shown) or a scanner (not shown). Images may also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm may be stored in any of the storage devices heretofore mentioned and applied to images in order to extract information used to embed steganographic data.

A preferred data embedding technique is disclosed in Honsinger, et al., U.S. Pat. No. 6,044,156, issued Mar. 28, 2000, entitled “Method For Generating An Improved Carrier For Use In An Image Data Embedding Application”. Here, an original image is represented as the two-dimensional array, I(x, y), the image with embedded data, I′(x, y), and a carrier is defined as C(x, y). A message is data encoded as a set of bits, and for the present invention the data is organized and contained within a two-dimensional array, M(x, y), and in the following the message and the two-dimensional representation of the message will be considered identical. A message that is embedded, M(x, y), in one form is an image. The message can represent an icon, for example, a trademark, or may represent the bits in a binary message. In the latter case the on and off states of the bits are represented as plus and minus ones, or positive and negative delta functions (spikes) which are placed in predefined and unique locations across the message image. Examples of iconic data types are trademarks, corporate logos or other arbitrary images. Performance generally decreases as the message energy increases so edge maps of the icons are used. Examples of binary data types are binary representations of identification codes, and copyright notations, verification information or authentication information.

With these definitions, the preferred embedding equation is:

I′(x, y)=α(M(x, y)*C(x, y))+I(x, y), (1)

where the symbol, *, represents circular convolution and α is an arbitrary constant chosen to make the embedded energy simultaneously invisible and robust to common processing. From Fourier theory, spatial convolution in the frequency domain is the same as adding phase while multiplying magnitudes. Therefore, the effect of convolving the message with a carrier is to distribute the message energy in accordance with the phase of the carrier and to modulate the amplitude spectrum of the message with the amplitude spectrum of the carrier. If the message were a single delta function and the carrier of random phase and of uniform Fourier magnitude, the effect of convolving with the carrier would be to distribute the delta function over space. Similarly, the effect of convolving a message with a random phase carrier is to spatially disperse the message energy.

The preferred extraction process is to correlate with the same carrier used to embed the image:

I′(x, y)\mathring{x}C(x, y)=α(M(x, y)*C(x, y))\mathring{x}C(x, y)+I(x, y)\mathring{x}C(x, y), (2)

where the symbol, \mathring{x}, represents circular correlation. Correlation is similar to convolution in that Fourier magnitudes also multiply. In correlation, however, phase subtracts. Therefore, the phase of the carrier subtracts on correlation of the embedded image with the carrier leaving the message. Indeed, if we assume that the carrier is designed to have uniform Fourier amplitude, then, and the process of correlation of the carrier on the embedded image Eq. 2, can be reduced to:

I′(x, y)\mathring{x}C(x, y)=αM(x, y)+noise (3)

That is, the process of correlation of the embedded image with the carrier reproduces the message image plus noise due to the cross correlation of the image with the carrier.

Tiling the dispersed message on the original image improves the robustness of the algorithm. For this invention, a single 128×128 dispersed message is tiled over the entire image. Upon extraction, each 128×128 region is aligned and summed to produce the final message. As disclosed in copending application, U.S. Ser. No. 09/453,247, filed Dec. 2, 1999, entitled “Method And Computer Program For Extracting An Embedded Message From A Digital Image,” by Chris W. Honsinger, for imaging applications with severe quality loss, such as small images printed using ink-jet printers on paper, a weighting factor that depends on the estimated signal-to-noise ratio can be calculated and applied to each extracted message element before summation.

If we denote the extracted message as M′(x, y), we can rewrite the equations for extracting the message (Eq. 2 and Eq. 3), above as:

M′(x, y)=αM(x, y)*(C(x, y)\mathring{x}C(x, y))+noise (4)

The above equation suggests that the resolution of the extracted message is fundamentally limited by the auto-correlation function of the carrier, C(x, y)\mathring{x}C(x, y). Any broadening of C(x, y)\mathring{x}C(x, y) from a delta function will blur the extracted message when compared to the original message. Another way to view the effect of the carrier on the extracted message is to consider C(x, y)\mathring{x}C(x, y) as a point spread function, since convolution of the original message with C(x, y)\mathring{x}C(x, y) largely determines the extracted message.

The design of the carrier should consider both visual detection of the embedded signal and the expected signal quality of the extracted signal. There is clearly a design tradeoff between achieving optimum extracted signal quality and embedded signal invisibility.

A carrier designed for optimal extracted signal quality will possess increasing amplitude with increasing spatial frequency. This may be derived from the well-known characteristic of typical images that the Fourier amplitude spectrum falls as the inverse of spatial frequency. At low spatial frequencies, where typical images have their highest energy and influence on the extracted image, our carrier uses this result. In particular, the mean or DC frequency amplitude of our carrier is always zero. As spatial frequency is increased, the carrier amplitude envelope smoothly increases with increasing spatial frequency until about 1/16 to ⅕ of the Nyquist frequency.

For frequencies greater than this, the carrier envelope can optionally be derived from a Contrast Sensitivity Function (CSF). Use of the CSF in an image embedding application is described in detail in Daly, U.S. Pat. No. 5,905,819, issued May 18, 1999, entitled “Method And Apparatus For Hiding One Image Or Pattern Within Another”.

The CSF provides a measure of the sensitivity of the average observer to changes in contrast at a given spatial frequency. The reciprocal of the CSF can be used to prescribe the amount of amplitude needed for the embedded signal to be detectable by an average viewer. Many modem CSF models facilitate for observer viewing distance, background noise, receiver dot density, color component wavelength and other factors.

Use of these CSF parameters can be an advantage when optimizing an embedding algorithm for a specific application. One particularly useful way of sizing the embedding algorithm for a specific system is to define the quality of the embedded signal in terms of the viewing distance at which the embedded signal can be visually detected. Once this is defined, an optimized carrier can be immediately derived and tested.

For a binary message, the impact of this carrier envelope is to produce a very small side-lobe around each delta function. It may be argued that the side-lobes rob the algorithm of bandwidth. However, we have found that the destructive processes of compression, error diffusion, printing and scanning have a far greater influence on the bandwidth of the algorithm. In a binary message, these destructive processes are the limiting factor of the bit density and can be thought of as defining the minimum separation distance between the delta functions. Side-lobe interference may be considered minimal, as long as the side-lobes are confined to within half of the minimum bit-separation-distance.

Correcting for rotation, scaling and skew is a fundamental element of all robust data embedding techniques. In Honsinger, et al., U.S. Pat. No. 5,835,639, a preferred method of correction of rotation and scale is provided. The correction technique relies on auto-correlation of the embedded image. For example, upon auto-correlation of an embedded image that has not been rotated or scaled, we would expect to see correlation peaks spaced horizontally and vertically at intervals of 128 pixels and 128 lines. At the zero offset correlation point, there is a very high peak due to the image correlating with itself.

Now, if the embedded image is scaled, the peaks must scale proportionately. Similarly, if the embedded image is rotated, the peaks must rotate by the same amount. Therefore, the rotation and scale of an image can be deduced by locating the auto-correlation peaks. Detection of the actual rotation angle θ is limited to angles in the range (−45°, +45°]. However, the actual rotation angle will be a member of the set θ_{actual}=θ_{calculated}±n90°, where n is an integer. Because we test for the possibility that the image has been flipped or rotated in increments of 90 degrees during the message extraction process, this ambiguity is not a fundamental limitation.

The effect of the auto-correlation properties of the original image can be significant. Without ancillary processing, high amplitude low frequency interference in the auto-correlation image can make the process of detecting peaks difficult. To minimize this problem, practice of the invention disclosed in U.S. Ser. No. 09/452,415 is performed. Here, localized first order and second order moment normalization on the embedded image is applied before the auto-correlation. This process consists of replacing each pixel in the image with a new pixel value, ν_{new}:

$${v}_{new} = \frac{{σ}_{desired}}{{σ}_{old}} ( {v}_{old} - {m}_{old} ) \qquad ( 5 )$$

where ν_{old}, is the original pixel value, m_{old}, is the local mean of the image, σ_{desired} is the desired standard deviation, which is generally set to the expected embedded signal standard deviation and σ_{old} is the local standard deviation. Because this operation is over a small area, typically over a (3×3) or (5×5) region, its effect in removing the high amplitude, low frequency coherent noise is quite substantial. For the limiting case when σ_{old} →0, we simply equate ν_{new} to a value taken from a random noise generator having a standard deviation σ_{desired}.

The next piece of ancillary processing performed is to shape the auto-correlation peaks also described in Honsinger, et al., U.S. Pat. No. 5,835,639, and in U.S. Ser. No. 09/452,415. This is done during the FFT operation used in the auto-correlation processing. A function that increases linearly with spatial frequency in the Fourier magnitude domain is quite satisfactory. This function is consistent with a Wiener filter designed to maximize the semblance of the correlation peaks to delta functions under the assumption that the image Fourier amplitude spectrum exhibits an asymptotic “1/(spatial frequency)” falloff. Following these processing steps produces peaks that need little further processing.

Importantly, because auto-correlating the embedded image requires no calibration signal, it does not tax the information capacity of the embedding system. In the art and science of steganography, reserving as much information capacity for the data is of paramount importance. Because of this, using the auto-correlation technique provides a significant improvement over the teachings of Rhoads, U.S. Pat. No. 5,832,119, issued Nov. 3, 1998, entitled “Methods For Controlling Systems Using Control Signals Embedded In Empirical Data,” because for this system a “subliminal graticule” or extra signal must be used to correct for rotation or scale.

The ability to recover from cropping is an essential component of a data embedding algorithm. If we were to extract from an arbitrarily located 128×128 region of an embedded image, then the extracted message would probably appear to be circularly shifted, since it is unlikely that the extraction occurred along the original message boundary.

Indeed, if the origin of the 128×128 extracted region was a distance, (Δx,Δy), from its nearest “original” origin, then the extracted message, M′(x, y) can be written as:

M′(x, y)=M(x, y)* δ(x−Δx, y−Δy) (6)

where we have assumed that the convolution is circular, that the carrier auto-correlated to a delta function and that the image contributes no noise.

On the surface, this circular shift ambiguity is a severe limitation on data capacity because it imposes the constraint that the message structure must be invariant to cyclic shifts. However, a way around this is found in U.S. Ser. No. 09/453,160, filed Dec. 2, 1999, entitled “Method and Computer Program for Embedding and Extracting An Embedded Message From A Digital Image,” by Chris W. Honsinger, that places the bits in the message in a special manner. First, required is a message-template, that is, a prescription of where to place the bits in a message image. The message-template is derived by placing positive delta-functions on a blank 128×128 image, such that each delta-function is located a minimum distance from all others, and such that the auto-correlation of the message-template yields as closely as possible, a delta-function. That is, the bits are placed such that the message-template, auto-correlation sidelobes are of minimal amplitude.

Now, correlating the extracted region with a zero mean carrier guarantees that the extracted circularly shifted message M′(x, y) is also zero mean. If we call the message-template, T(x, y), then the absolute value of the the extracted template must be practically equivalent to a circularly shifted message-template. That is,

|M′(x, y)|=T(x, y)*δ(x−Δx, y−Δy) (7)

This implies, due to the auto-correlation property of the message-template, that the shift from the origin of the message can be derived by correlating |M′(x, y)| with T(x, y), since:

|M′(x, y)|\mathring{x}T(x, y)=δ(x−Δx, y−Δy) (8)

Therefore, the result of the correlation will be a 128×128 image, whose highest peak will be located at the desired shift distance, (Δx, Δy). This peak location can be used to correctly orient the positions of the embedded bits.

Following the above prescription for data embedding results in a highly robust system for transmission of data on printed materials and electronic image files.

Because of the generality of the rotation and scale algorithm used and the efficiency of the data carrying technique, the data extraction techniques as described above works under very stressful, and uncontrolled conditions, including cropping, paper wrinkling, pen marking, rotating, skewing, shearing and even mild warping. These conditions can be known or unknown beforehand. In either case, the algorithm as described above works well.

A more specific class of embedding and extraction is when the printing and scanning conditions are known beforehand. It is possible, for example, to ensure that Photo ID cards are printed and scanned with conditions known beforehand. If the embedded data cannot be extracted, it can be assumed the Photo ID is fraudulent and rejected. Similarly, consistent printing and scanning conditions can be ensured for postage stamps, prints of pictures, and business forms. When the conditions are known beforehand, an opportunity for adding bandwidth to the embedding algorithm is present by pre-structuring the embedded data to mimic the effect a rotation, scale or skewing transformation would have on the embedded message. Since the actual rotation, scale, and skewing induced by the print and scan cycle can be deduced, any purposeful inducement of rotation, scale or skewing can be used to convey further information, and therefore is a means of storing data.

A simple example of this is a Photo ID cards system wherein the scanner used is a flatbed scanner. For the sake of clarity, assume that the flatbed scanner is custom made for this application. This custom flatbed scanner is developed so as to guarantee that rotation is not an issue. For example, when a user inserts the photo ID into the scanner entry, physical guides are placed such that the Photo ID card cannot be rotated and is inserted to a known depth. The scanned photograph on the ID Card does not need to be subjected to the auto-correlation algorithms described above because the rotation, scale and skewing are known. At the time of this writing, we have shown empirically the auto-correlation technique described above combined with the extraction of the bits in the photograph can be performed in less than 0.45 seconds using typical computer processors (Pentium II). This timing is well within the specifications of most Photo ID equipment manufacturers.

Consequently, using the auto-correlation techniques described above is well within the requirements, and it might as well be used. Therefore, if the tiled dispersed messages were rotated at various angles, say every degree, then an additional 360 states or 8.49 bits of information can be addressed! Similarly, if the resultant scale or magnification is static for the printer and the scanner, more states of information can be induced.

As a parenthetical observation, the use of a steganographic signal to form the rotated auto-correlation peaks is strictly not necessary. The use of any sufficiently random sequence of numbers can be substituted for the steganographical message data.

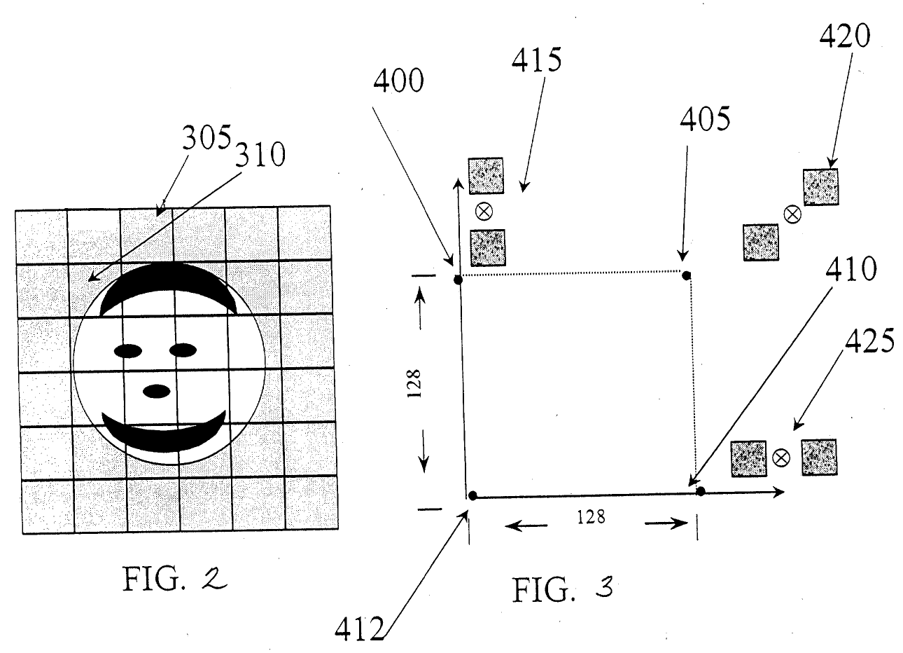

For the sake of clarity, FIG. 2 represents the picture printed on the aforementioned ID card. The ID card contains a picture 305 of the person possessing the identification document. The picture 305 is originally 768 pixels×768 lines, and is embedded with a convolved message that has been tiled across the image. An example tile is depicted 310. Since the preferred carrier and preferred message image are 128 pixels×128 lines, there are 36 tiles total in the photograph, six spanning the horizontal axis and six spanning the vertical axis. The auto-correlation map of this embedded image, when not exposed to rotation, skewing or scaling is depicted in FIG. 3. The auto-correlation peaks are designated at arrows 400, 405, 410 and 412. Auto-correlation peak 400 is due to all tiles that are correlated vertically at a distance of 128 pixels. This vertical correlation is symbolically represented as 415. Similarly, auto-correlation peak 410 is due to all tiles that are correlated horizontally at a distance of 128 pixels. This horizontal correlation is represented symbolically as 425. Auto-correlation peak 405 is due to all tiles that are correlated diagonally at a distance of \sqrt{128²+282²} pixels. This diagonal correlation is symbolically represented as 420. Auto-correlation peak 412 is trivial and is due to all tiles correlating with themselves. This peak establishes the origin of the coordinate system.

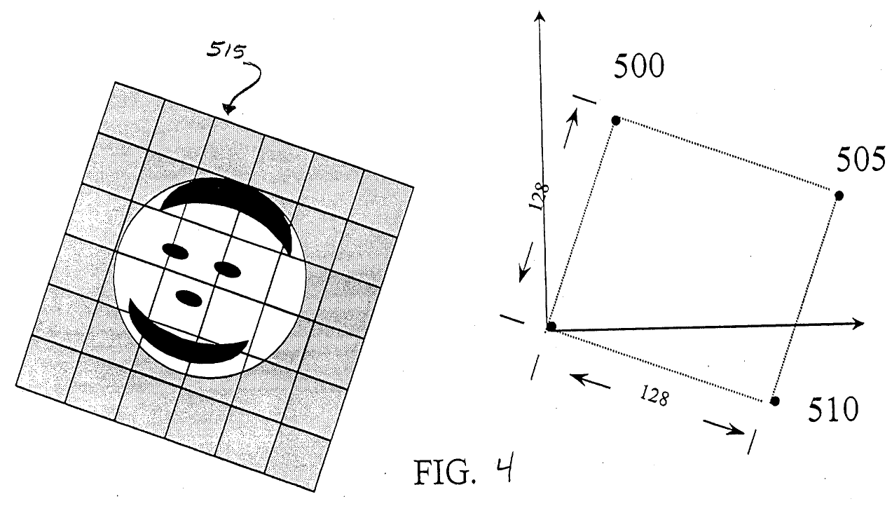

In a system where only rotation occurs, only one nontrivial auto-correlation peak need be known in order to determine the amount of rotation. For example, FIG. 4 shows the image 515 rotated at 20 degrees. Non-trivial auto-correlation maxima 500, 505 and 510 each corresponding, respectively, to 400, 405 and 410 in FIG. 3 have each been rotated by the same amount, 20 degrees. Any one of these peaks, 500, 505 or 510, may be used to deduce the rotation angle.

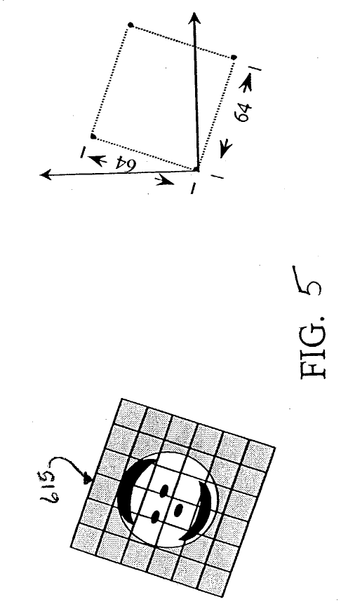

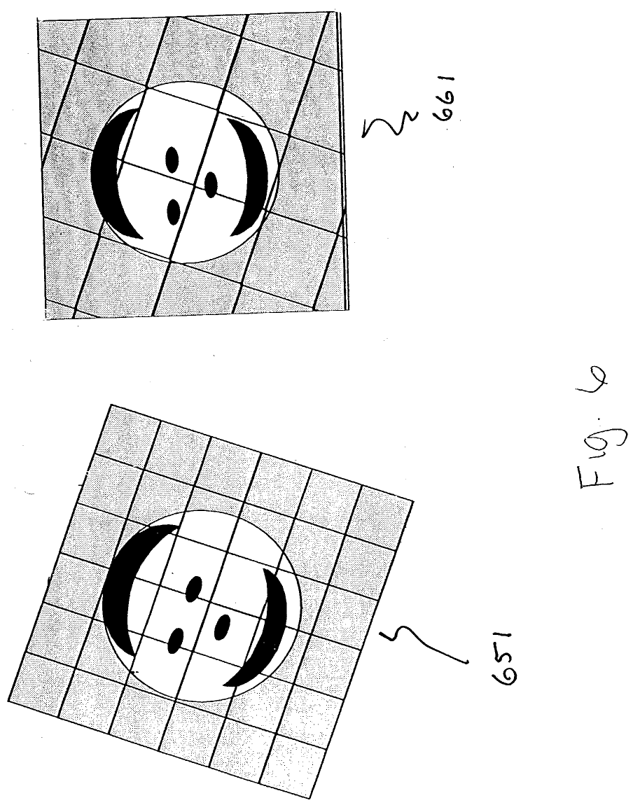

So long as the image maintains its aspect ratio, the requirement for needing only one auto-correlation peak to determine the amount of geometric transformation can be extended to scaling. In fact, this kind of scaling can be performed in combination with rotation. FIG. 5 shows an image 615 that has been reduced in scale by 50% and rotated by 20 degrees. In contrast, if one dimension was scaled by 50% and the other maintained at 100%, two nontrivial auto-correlation peaks would be needed. However, scaling by unequal amounts in two directions is more simply treated under a general affine transformation, which will be discussed later.

It is useful to develop an equation that describes the bit capacity available to a purposefully induced rotation or scale. First, however, a purposefully induced rotation or scaling will be defined as a steganographic signal that has been rotated or scaled and thereafter combined with the image, audio, or video data. FIG. 6 shows a steganographically encoded facial image that has undergone rotation and scale 651, whereas 661 shows the face image with a purposefully induced rotation and scale applied to the steganographic signal. Since a rotation scale has one unique auto-correlation peak as described above, calculation of the added bit capacity is rather simple.

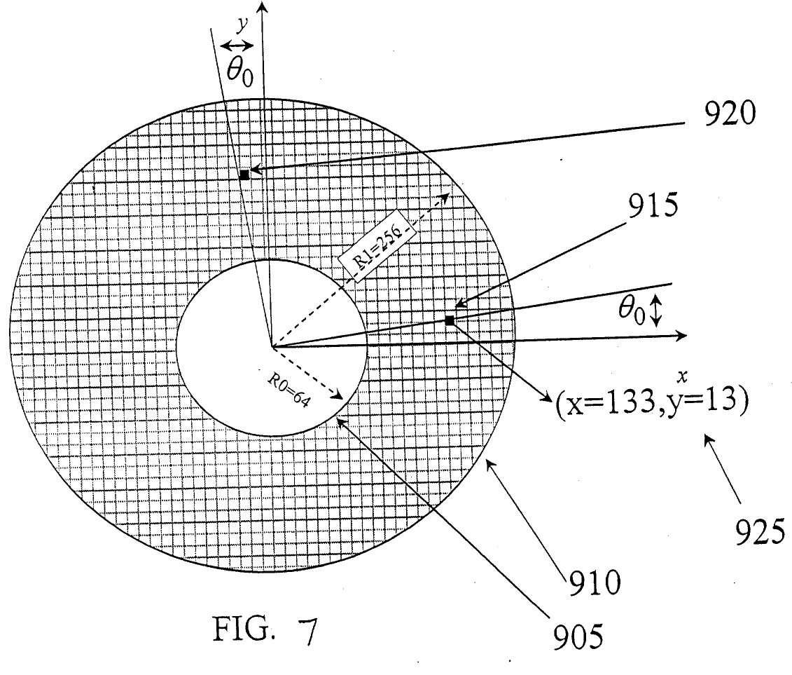

Assume, first, that there is a minimum and maximum scaling factor for each application of this invention. Clearly, a scale factor of zero is not reasonable—no information could be transferred. Similarly, a maximum scale factor of one million is not reasonable—images and video are generally too small to capture this high of a level of scaling in the form of a repetitious pattern. We have found, when using the preferred carrier size of 128×128 and a scale factor between 0.5 and 2.0, that all applications disclosed herein sustain the high performance of the algorithms disclosed in this invention. We have also found that there are no limitations on the rotation angle. FIG. 7 summarizes these findings. FIG. 7 designates an auto-correlation map of the possible purposefully induced auto-correlation peaks for rotation and scale (aspect ratio maintained). Inner radius 905 designates the lower bound of a scaling of 0.5 of a 128×128 carrier and message. Outer radius 910 designates the maximum radius of a scaling of 2.0. Auto-correlation peaks 915 and 920 depict the auto-correlation peaks of an image that has been rotated and scaled slightly. Because only one of these auto-correlation peaks is unique, the number of states of extra information that can be transmitted is equal to the number of auto-correlation peaks that can be discriminated in the area bounded by the minimum and maximum circles 905 and 910. This area is

$$\frac{π ( {r}_{1}^{2} - {r}_{0}^{2} )}{{Δ}^{2}}$$

where Δ² is the spatial area of a discernible auto-correlation peak.

Following the prescription above for a carrier and for message payload sizes of 64-100 bits, we have found that a practical value for Δ²=2.25. Therefore, if the carrier size is 128, r₁=256, and r₀=64, then the number of states is 85,786. This yields a bit capacity of 16.38 bits. This bit capacity is sufficient for uses such as: a checksum; a small public key to an encrypted steganographic payload; an index into the type of steganographic algorithm used; a hash of a senders or receiver's address on a postal envelope; the amount of postage; a monetary value for a currency; or any other piece of information that bits or symbols can represent. Moreover, an important aspect of this invention is that the information is available publicly.

In the case of the postage stamp, for example, the value of the stamp may be very important to many nodes of the postal delivery process. Postal authorities may not wish that all nodes have access to the signal that is steganographically embedded, that is, the information that requires a key (carrier) to decode. Therefore, the invention can be used to convey information that is available publicly and privately.

This is important because one skilled in the art could use any random sequence to convey information by periodically tiling the information consistent with a known affine transform. Consequently, this opens applications up to counterfeiting. If one additionally requires, however, that the random sequence contains further information and keeps the keys secret, the usefulness of the invention dramatically improves—the possibility of conveying public and private information is effected.

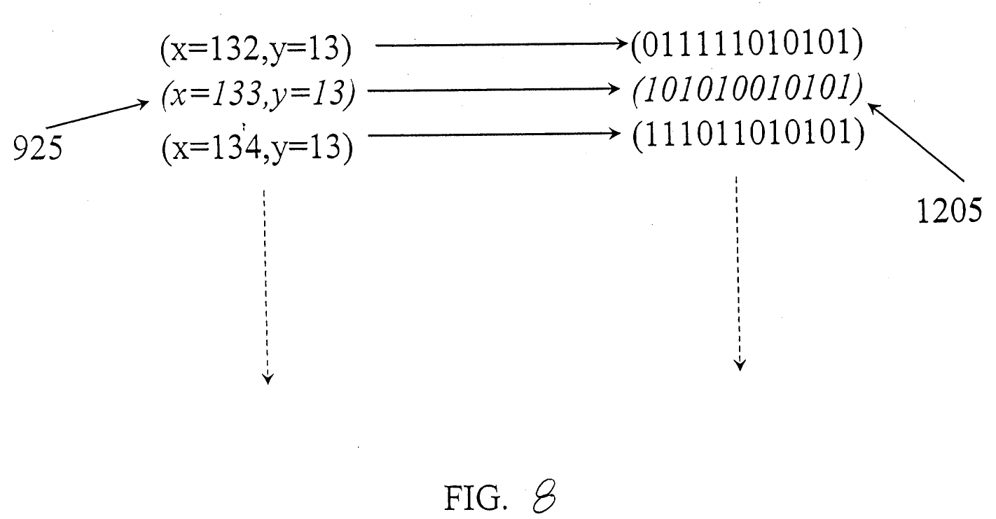

Referring again to figure FIG. 7, assume the auto-correlation map of a Photo ID card yielded the auto-correlation map shown in FIG. 7. Assume further, that auto-correlation peak 915 was found to occur at coordinates 925. To find the public information associated with the peak, the extraction software preferably accesses a two-dimensional look up table FIG. 8. As shown in FIG. 8, the coordinates 925 are used as an index to find the public information 1205. This public information is maintained in memory. Now it should be noted that if the image was rotated at a large angle, say 80 degrees, then there is no way to tell if auto-correlation peak 915 or auto-correlation peak 920 points to the correct public information! One way around this is to simply restrict the number of bits (or equivalently the number of synthetic rotations and scales). However, in the preferred data-embedding algorithm described above, corrections for all scalings and rotations within the region described by FIG. 7 are possible. Recall from the above discussion that detection of the actual rotation angle θ is limited to angles in the range (−45°, +45°]. However, the actual rotation angle will be a member of the set θ_{actual}=θ_{calculated}±n90°, where n is an integer. Because we test for the possibility that the image has been rotated in increments of 90 degrees during the message extraction process, this ambiguity is not a fundamental limitation. This testing is achieved by rotating, scaling or skewing (in general, performing the inverse affine transform) a manageable region of the acquired image back to a candidate original form. This candidate image region is then correlated with the carrier. The candidate with the strongest signal strength is taken as the actual transformation. Once this has been determined, then the public information can be used as a checksum used to validate the steganographic payload, an index used to determine the type or version of a steganographic method, a hash of a senders' and/or receivers' address on a “custom made” stamp, the amount of postage when applied to a stamp, a monetary value for a stamp or a currency, a public key needed to decode the steganographic payload that was encoded using a public-private key system, or an index into a database containing multiple actions that a machine may perform.

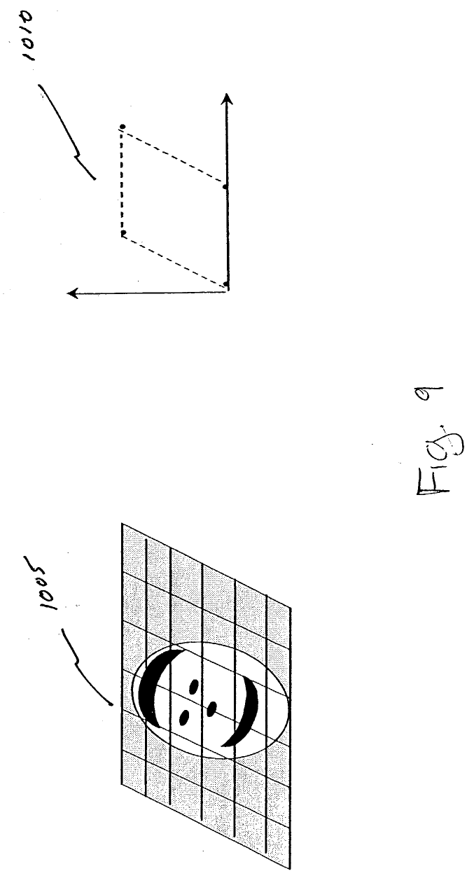

As discussed earlier, in the case of skewing, two independent, nontrivial auto-correlation peaks are present. This implies that more information can be transmitted than in the case of using only rotation and scale. FIG. 9 shows an example of a skewed image 1005 and an auto-correlation map 1010 of the skewed image. Unlike pure rotation and scale that preserves the 90° angles of the dispersed tiled messages on the images, with skewing, or equivalently, shearing, these angles are not preserved. Fortunately, with skewing, the resulting tiled dispersed messages are each of identical shapes. Having identical shapes is why the auto-correlation technique for geometric correction works on skewed imagery. Mathematically, a skew is nothing more than an affine transform:

$$[ \begin{matrix}{x}^{′} \\ {y}^{′} \\ 1\end{matrix} ] = [ \begin{matrix}{a}_{1} & {a}_{2} & {a}_{0} \\ {b}_{1} & {b}_{2} & {b}_{0} \\ 0 & 0 & 1\end{matrix} ] [ \begin{matrix}x \\ y \\ 1\end{matrix} ] \qquad ( 9 )$$

The values (x′, y′) represent the coordinates the image is transformed to. Likewise, the values (x, y) represent the coordinates that describe the original image. Recall that translation, or resistance to cropping, is achieved by synchronizing with a message template. Moreover, after auto-correlation, translation is not present anyway since the auto-correlation peaks occur not at an absolute position, but at a relative position. Therefore, the translation component of Eq. 9 can be zeroed out and the following simplified equation results:

$$[ \begin{matrix}{x}^{′} \\ {y}^{′}\end{matrix} ] = [ \begin{matrix}{a}_{1} & {a}_{2} \\ {b}_{1} & {b}_{2}\end{matrix} ] [ \begin{matrix}x \\ y\end{matrix} ] \qquad ( 10 )$$

Because this is nothing more than a linear mapping, dispersed messages tiles are generally transformed to equally dimensioned parallelograms. For a rotation scale combination, as in the case treated above, Eq. 10 reduces to:

$$\{ \begin{matrix}{a}_{1} = {b}_{2} = s cos ( θ ) \\ {a}_{2} = - {b}_{1} = s sin ( θ )\end{matrix} \qquad ( 11 )$$

where, s=scale and θ=rotation angle. For any other values for a₁,a₂,b₁,b₂, the resulting auto-correlation peaks have two nontrivial peaks from which information can be transmitted.

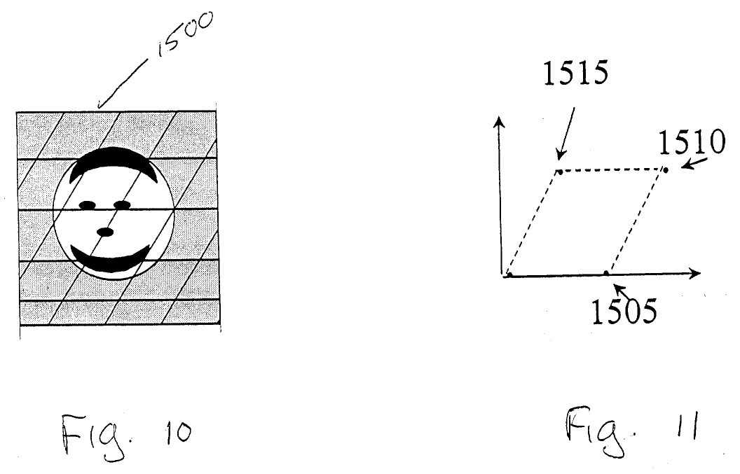

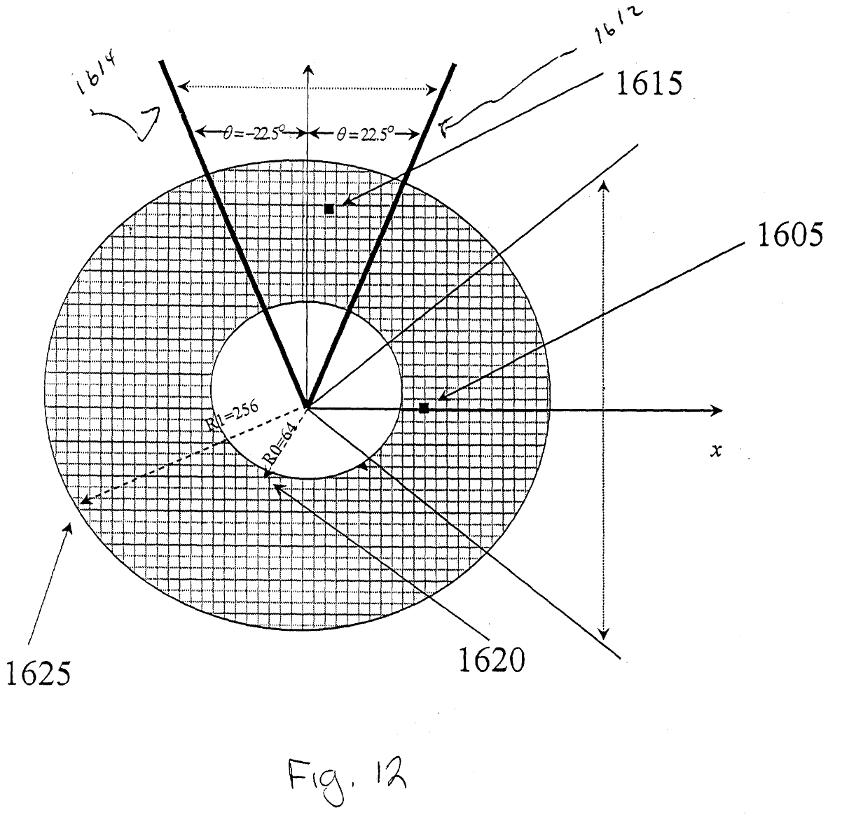

Equation 10 can be used to purposely induce these parallelograms. An image 1500 with a purposely induced affine transformation that has two nontrivial auto-correlation peaks is depicted in FIG. 10. The auto-correlation map of such a purposively induced affine transform is shown in FIG. 11. Auto-correlation peak 1505 can be treated identically as the single independent auto-correlation peak is calculated under a pure rotation scale. The location of auto-correlation peak 1510 is a vector sum of auto-correlation peak 1505 and 1515. This peak may be used to discern the extra degree of freedom, but it is simpler to treat 1515 as a solely independent auto-correlation peak.

An expanded view of an auto-correlation map generated by a purposely induced affine transform is depicted in FIG. 12. Auto-correlation peaks 1605 and 1615 are independent. This is unlike the case when the affine transform is restricted to purely rotation and scale because the angle between the two peaks is not guaranteed to be 90°.

For clarity and without losing generality, auto-correlation peak 1605 can be thought of as being a result of a rotation and/or scaling. The information capacity for auto-correlation peak 1605 therefore is the same as calculated above and the specific information associated with this peak can be calculated using the same algorithm as described earlier. Now, it is expeditious to consider auto-correlation peak 1615 relative to auto-correlation peak 1605, otherwise the mathematics becomes very obscure. Experimentation has shown that auto-correlation peak 1615 should be placed between line 1612 (90°-22.5°) and line 1614 (90°+22.5°) from auto-correlation peak 1605. Furthermore, experimentation has shown that auto-correlation peak 1615 should reside in the region bounded by circles 1625 and 1620. This corresponds to a magnification of 0.5 and 2.0 for a carrier size of 128. Deviating from this placement prescription degrades the information capacity of the embedded payload, that is, the data carried in the convolved message. Since the placement of auto-correlation peak 1615 is independent of auto-correlation peak 1605 inside the bounded region, the number of additional independent states associated with the peak available for transmitting information is:

$$\frac{π ( {r}_{1}^{2} - {r}_{0}^{2} )}{8 {Δ}^{2}}$$

where Δ² is the spatial area of a discernible auto-correlation peak. It is virtually identical to the number of states calculated for the pure rotation and scale calculation with the exception that it is smaller because only 45° can be used instead of the full 360°. Following the prescription above for a carrier and for message payload sizes of 64-100 bits, we have found that a safe value for Δ²=2.25. Therefore, if the carrier size is 128, r₁=256, and r₀=64, then the number of states associated with this second peak is 85,786/8=10723. This translates to extra 13 bits of information.

The invention has been described in detail with particular reference to certain preferred embodiments thereof, but it will be understood that variations and modifications can be effected within the spirit and scope of the invention.

### PARTS LIST

110 computer system

112 microprocessor-based unit

114 display

116 keyboard

118 mouse

120 selector

122 externally located disk unit

124 compact disk-read only memory (CD-ROM)

126 floppy disk

127 network connection

128 printer

130 personal computer card (PC card)

132 externally located PC card reader

134 digital camera

136 camera docking port

138 cable connection for digital camera

140 wireless connection for digital camera

305 picture

310 example tile

400 auto-correlation peak

405 auto-correlation peak

410 auto-correlation peak

412 auto-correlation peak

415 vertical correlation

420 diagonal correlation

425 horizontal correlation

500 non-trivial auto-correlation maxima peak

505 non-trivial auto-correlation maxima peak

510 non-trivial auto-correlation maxima peak

515 image

615 image

651 steganographically encoded facial image that has under-gone rotation and scale

661 face image with a purposefully induced rotation and scale applied to the steganographic signal

905 inner radius

910 outer radius

915 auto-correlation peak

920 auto-correlation peak

925 coordinates

1005 skewed image

1010 auto-correlation map of the skewed image

1205 public information

1500 image with a purposely induced affine transformation

1505 auto-correlation peak

1510 auto-correlation peak

1515 auto-correlation peak

1605 auto-correlation peak

1612 line

1614 line

1615 auto-correlation peak

1620 circle

1625 circle

What is claimed is:

1. A method of embedding information in an image or video signal, comprising the steps of:
a) associating information with an affine transformation, to form associated information;
b) inducing the effect of the affine transformation on an array of steganographically encoded signals, to form a transformed steganographic signal, and;
c) combining the transformed steganographic signal with the image or video signal.

2. The method as in claim 1 wherein the associated information represents an encryption key needed to decode a steganographically encoded signal.

3. The method as in claim 1 wherein the associated information represents a checksum of the steganographically encoded signal.

4. The method as in claim 1 wherein the associated information represents a hash code of a sender or receiver address.

5. The method of claim 2 wherein the key is public.

6. The method of claim 2 wherein the key is private.

7. The method of claim 6 wherein the steganographically encoded information is used to authenticate the associated information.

8) The method of claim 1 wherein the associated information represents a reference to the steganographic algorithm used to encode the steganographically encoded signals.
